(19) United States
(12) Patent Application Publication
(10) Pub. No.: US 2012/0320204 A1
(43) Pub. Date: Dec. 20, 2012

(54) ASSET ASSESSMENT SYSTEM

(75) Inventor: Thomas J. Dahlin, St. Louis Park, MN (US)

(73) Assignee: 3M Innovative Properties Company

(21) Appl. No.: 13/164,500

(22) Filed: Jun. 20, 2011

(51) Int. Cl. H04N 7/18; G01C 21/34

(52) U.S. Cl. 348/148; 348/E07.085

(57) ABSTRACT

An asset assessment system that gathers information about a plurality of assets located at various geographical locations.

### TECHNICAL FIELD

The present invention relates to an asset assessment system that gathers information about a plurality of assets located at various geographical locations.

### BACKGROUND OF THE INVENTION

Often organizations are responsible for monitoring and maintaining a variety of assets located at different geographical locations. One example of such assets is the many millions of roadway signs and structures necessary to keep roadways safe and traffic flowing, which present a particular logistical challenge for those responsible for the installation and maintenance of those signs and structures, such as department of transportation personnel. Signs and structures must be properly installed in the necessary locations and an inventory of those signs and structures must be maintained for future reference. Moreover, the signs and structures must be inspected on a periodic basis and serviced or maintained, such as repaired or replaced, when necessary.

Field workers are often dispatched on a periodic basis to inspect installed signs. The field workers must first determine what subset of all installed signs must be inspected. Then, the field workers must locate that large number of signs requiring inspection, assess the condition of those signs, and document whether or not maintenance is necessary. Often when maintenance is necessary, the field worker performs the necessary repairs or replacements contemporaneously with the inspection and documents such maintenance activity. When performing such maintenance, it is also desirable to have available for the field workers information associated with each sign, such as installation date and past maintenance. Similarly, at a central office, such as a department of transportation, it is also desirable to have available information associated with installed signs for purposes of recalls or replacement scheduling. The process of planning an appropriate inspection route for the field worker, evaluating the signs, assessing the inventory of signs and documenting necessary repair work or repair work performed can be an inefficient process with many opportunities for error in paperwork and location of signs.

PCT Publication WO 96/35196, “Automated Sign Inventory System,” (Bantli et al.) discloses embodiments of systems for automating maintenance and inventory of roadway signs and structures. In this disclosure, the system either receives location data regarding the asset from a GPS satellite or from a geographic information system.

The United States Department of Defense has deployed a constellation of twenty-four or more satellites into the earth's orbit as the central component to the Global Positioning System (GPS). GPS is well known and has many defense and civilian uses. From the deployed satellites, any user equipped with appropriate GPS receivers can determine their position anywhere in the world to within 100-15 meters, and even to within 3-5 meters or 1-3 meters. For example, low cost GPS receivers can determine their position anywhere in the world to within 100-15 meters, and more expensive GPS receivers often can determine their position to less than a meter. GPS receivers receive high frequency signals broadcast from the satellites and from the signals, and can calculate their location.

### SUMMARY OF THE INVENTION

One aspect of the present invention provides an asset assessment system. In this aspect, the asset assessment system comprises: a plurality of assets located at various geographical locations; a geographical information system database for providing information relating to geographical locations of the plurality of assets; an on-board global positioning system device; a camera; a pointing controller, wherein the camera is attached to the pointing controller; and a computer, wherein the computer receives information from the geographical information system database and the global positioning system device to direct the pointing controller where to point the camera. Another aspect of the present invention provides an alternative asset assessment system. In this aspect, the asset assessment system comprises: a plurality of assets located at various geographical locations; a geographical information system database for providing information relating to geographical locations of said plurality of assets; an on-board global positioning system device; a plurality of cameras directed at different positions; and a computer, wherein the computer receives information from the geographical information system database and the global positioning system device and selects a camera from the plurality of cameras.

In one embodiment of the above asset assessment systems, the camera pointed at a selected asset from the plurality of assets records at least one image of the selected asset. In another embodiment, the system further comprises a retroreflectivity measurement apparatus. In yet another embodiment, the plurality of assets includes roadway signs or roadway structures. In another embodiment, the system further comprises a user interface to allow a user to read information and input information about the assets. In another embodiment, the system collects assessment information about the asset, and wherein the assessment information includes inventory, maintenance, or incidental sign evaluation information. In yet another embodiment, the system further comprises a radio frequency identification (“RFID”) reader with a steerable antenna, wherein each asset includes a radio frequency-responsive element, and wherein the computer steers the RFID antenna in the direction of a selected asset from the plurality of assets to read information from the radio frequency-responsive element of the selected asset. In another embodiment, the system further comprises a database for storing all information gathered by the asset assessment system relating to the plurality of assets. In yet another embodiment, the computer calculates the optimized location of the vehicle for the camera to take an image of a selected asset, and communicates directions to a driver of the vehicle to that optimized position.

Yet another aspect of the present invention provides an alternative asset assessment system. In this aspect, the asset assessment system comprises: a plurality of assets located at various geographical locations, wherein each asset includes a radio frequency-responsive element; a geographical information system database for providing information relating to geographical locations of said plurality of assets and the individual radio frequency-responsive element information for each asset; an on-board global positioning system device; a radio frequency identification (“RFID”) reader with a steerable RFID antenna; and a computer, wherein the computer receives information from the geographical information system database and the global positioning system device and steers the RFID antenna in the direction of a selected asset from the plurality of assets to read information from the radio frequency-responsive element of the selected asset.

In one embodiment of the above asset assessment system, a selected radio frequency-responsive element has an antenna characteristic information, and the antenna characteristic is included in the geographical information system database. In another embodiment, the steerable antenna is optimized to read the selected radio frequency-responsive element based on its antenna characteristic information. In yet another embodiment, the system further comprises a pointing controller and a camera attached to the second pointing controller; and wherein the computer directs the pointing controller where to point the camera. In another embodiment, the camera pointed at a selected asset records at least one image of the selected asset. In yet another embodiment, the system further comprises a retroreflectivity measurement apparatus. In another embodiment, the plurality of assets includes roadway signs or roadway structures. In yet another embodiment, the system further comprises a user interface to allow a user to read information. In another embodiment, the system collects assessment information about the asset, and wherein the assessment information includes inventory, maintenance, or incidental sign evaluation information. In yet another embodiment, the system further comprises a database for storing all information gathered by the asset assessment system relating to the plurality of assets. In another embodiment, the computer calculates the optimized location of the vehicle for the RFID antenna to read the radio frequency-responsive element of a selected asset, and communicates directions to that optimized location.

Another aspect of the present invention provides a method of assessing assets. In this aspect, the method comprises: providing a geographical information system database for providing information relating a plurality of assets located at various geographical locations and the geographical locations of the plurality of assets; providing a camera to take an image of a selected asset; providing a global positioning system device; positioning the camera based on information about a selected asset from the geographical information system database and from the global positioning system; and taking an image of the selected asset.

In one embodiment of the above method, the method further comprises the step of: measuring retroreflectivity of the selected asset. In another embodiment, the plurality of assets includes roadway signs or roadway structures. In yet another embodiment, the method further comprises the step of: collecting assessment information about the selected asset, wherein the assessment information includes inventory, maintenance, or incidental sign evaluation information. In yet another embodiment, the method further comprises the steps of: providing further a radio frequency identification (“RFID”) reader with a steerable antenna, wherein each asset includes a radio frequency-responsive element; steering the RFID antenna in the direction of a selected asset from the plurality of assets to read information from the radio frequency-responsive element of the selected asset. In another embodiment, the method further comprises the step of: calculating the optimized location of the vehicle for the camera to take an image of a selected asset; and communicating directions to a driver of the vehicle to that optimized location.

### BRIEF DESCRIPTION OF THE DRAWINGS

The present invention will be further explained with reference to the appended Figures, wherein like structure is referred to by like numerals throughout the several views, and wherein:

FIG. 1 illustrates a typical roadway scene;

FIG. 2 illustrates a prior art retroreflectivity measurement apparatus;

FIG. 3 illustrates one embodiment of portions of the asset assessment system of the present invention;

FIG. 4 illustrates one embodiment of the general components of the asset assessment system of the present invention;

FIG. 5 illustrates a block diagram of one embodiment of the asset assessment system of the present invention including at least one camera;

FIG. 6 illustrates a top view of one embodiment of the asset assessment system of FIG. 5 interacting with a typical roadway scene;

FIG. 7 illustrates a top view of another embodiment of the asset assessment system of FIG. 5 interacting with a typical roadway scene;

FIG. 8 illustrates a top view of yet another embodiment of the asset assessment system of FIG. 9 interacting with a typical roadway scene; and

FIG. 9 illustrates a block diagram of one embodiment of the asset assessment system of the present invention including an RFID reader.

### DETAILED DESCRIPTION OF THE INVENTION

Safety concerns with roadway safety have intensified over the years because the driving environment has changed with more aging drivers, altered vehicle headlamp performance, diverse vehicle sizes, increased number of vehicles on the roads, and an increase in the amount of information conveyed to drivers. One U.S. Highway Department of Transportation, Federal Highway Administration report comments that although about one-quarter of all travel occurs at night, one-half of all fatalities occur during those hours. The report continues in stating that it is well known that darkness reduces the visual cues available to the driver and that traffic control devices, such as road signs, are harder to see at night. According to one U.S. Census Bureau report, by 2020, more than 50 million drivers will be over 65 years old, about one in five drivers. Nearly half of these drivers will be over 75 years old. Due to aging, there is a natural decline in eyesight, increased glare sensitivity, and slower reaction time. The U.S. Highway Department of Transportation, Federal Highway Administration recommends easier-to-see-and-read signs to help older drivers retain their freedom of mobility, remain independent, and reduce their likelihood of being involved in traffic crashes. One U.S. Highway Department of Transportation, Federal Highway Administration study noted that several motor vehicle models do not provide sufficient illumination towards mounted signs. Due to the expansion of sales of pickups and SUVs, there are a large number of diverse vehicles having varying observations angles. Observation angles impact driver's abilities to see and read road signs. Other factors impacting a driver's attention include the steady increase in the number of vehicles on roads and highway systems, and individual drivers are receiving more information from multiple sources, as he or she drives down the road.

To increase the visibility of roadway signs and other assets to drivers, the majority of signs incorporate retroreflective sheeting materials, which reflect incoming light towards its source to provide improved visibility during the night. Some examples of such retroreflective sheeting materials are commercially available from 3M Company based in St. Paul, Minn. as 3M™ Diamond Grade DG3 (DG Cubed) Reflective Sheeting Series 4000 and 3M™ Engineer Grade Reflective Sheeting Series 3270.

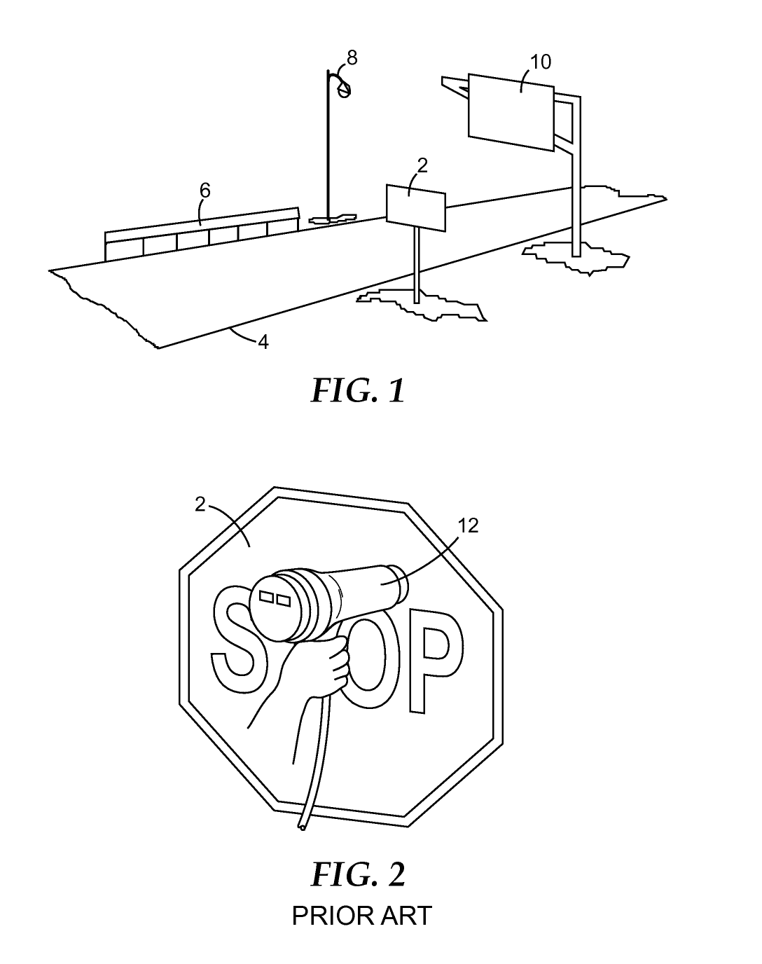

FIG. 1 illustrates a typical roadway scene, including various roadway assets that may include retroreflective materials. For example, such assets include sign 2, guard rail 6, and light pole 8, all of which are installed beside roadway 4. Overhead signs 10 mounted on overpasses or bridges may also include retroreflective materials. However, the asset assessment system of the present invention is not limited to roadway signs and the transportation system, and may be used with any type of asset unrelated to transportation or roadways.

Though traffic signs are strategically placed and nighttime visibility of signs has been increased by the use of retroreflective sheeting materials, it is further necessary that signs remain properly positioned and have at least a minimum retroreflectivity. As one means of addressing this, the U.S. Highway Department of Transportation, Federal Highway Administration passed federally-mandated minimum sign retroreflectivity standards requiring state and local agencies to assess the signs on their roads and develop a replacement plan. Specifically, signs and object markers used on streets, highways, bikeways, and pedestrian crossings require certain retroreflectivity measurements to maintain nighttime visibility. Thus, these federally-mandated standards require that each state or local agency assess each asset having retroreflective materials in its jurisdiction. Concurrently, each asset would preferably be assessed for other characteristics to determine whether it needs to be replaced, such as if the asset has been damaged or knocked over, and is no longer visible. Traditionally, this information has been gathered manually, requiring state or local personnel to drive to each asset's location, park their vehicle, and exit the vehicle to perform certain retroreflectivity measurements as shown in FIG. 2, and to record their observations about the asset. FIG. 2 illustrates a user holding up retroreflectivity measurement apparatus 12 to a stop sign to measure the current retroreflectivity of the sign 2. If the measured retroreflectivity does not meet the federally-mandated standards, then the sign would need to be replaced within a certain time frame. One example of a handheld retroreflectivity measurement apparatus is commercially available from RoadVista as Model 922 Handheld Sign Retroreflectometer.

The asset assessment system of the present invention provides an automatic and cost efficient means for gathering information about a collection of assets, in particular, a variety of assets located at different geographical locations. Such assessment information can be analyzed in the field or stored in a database for post processing. For example, the asset assessment system can collect information and analyze the presence or absence of the asset, its current condition, such as whether it is located at the correct location or whether it is orientated correctly, whether it requires maintenance, such as whether it is bent or damaged, and/or whether it meets certain requirements, such as retroreflectivity requirements, etc. These assets could include roadway signs, guard rails, or other assets or objects residing in areas accessible to mobile units that contain the asset assessment system of the present invention. The asset assessment system of the present invention efficiently locates the selected assets and gathers information about the selected assets with minimal manual effort by a user, thus saving time and expense. In addition, the asset assessment system of the present invention calculates and provides an optimized route for traveling to the different asset locations to assess each asset's condition. In one embodiment, the present invention is intended to assist department of transportation personnel with activity planning, record-keeping, and data entry in the activities of placing signs in the field, assessing their condition, and repairing or replacing them when necessary. The system results in an increased efficiency of the installation and maintenance activity with respect to signage and therefore can improve the overall safety of the transportation system. However, as mentioned above, the system is not limited to roadway signs and the transportation system, and may be used for any number of assets installed by a roadway or residing in areas accessible to mobile units equipped with the asset assessment system of the present invention, as described in more detail below.

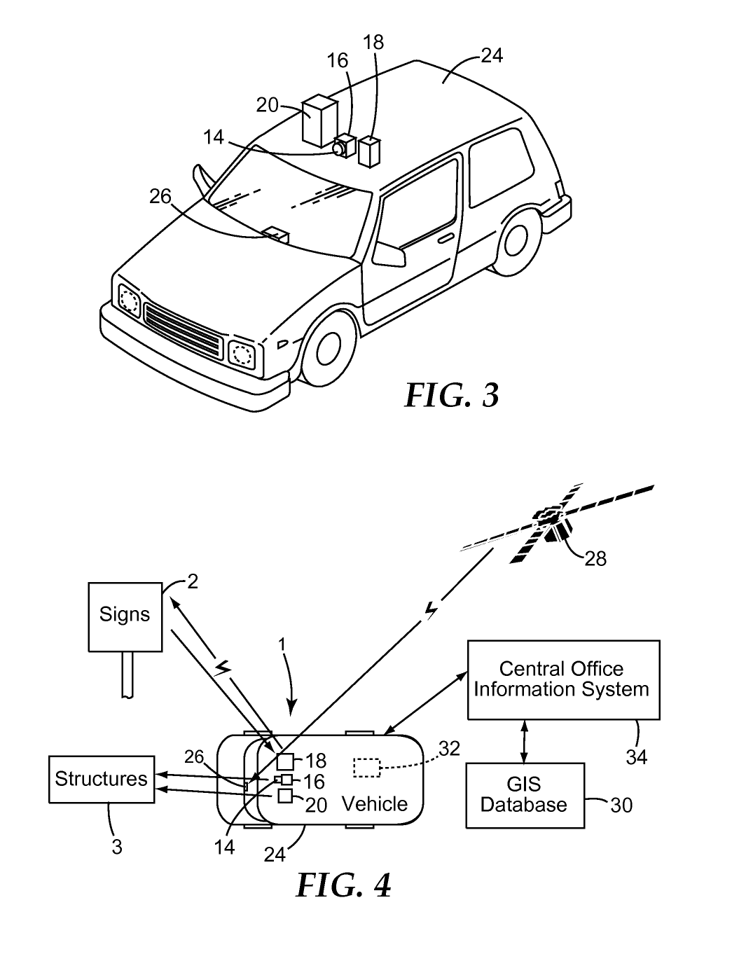

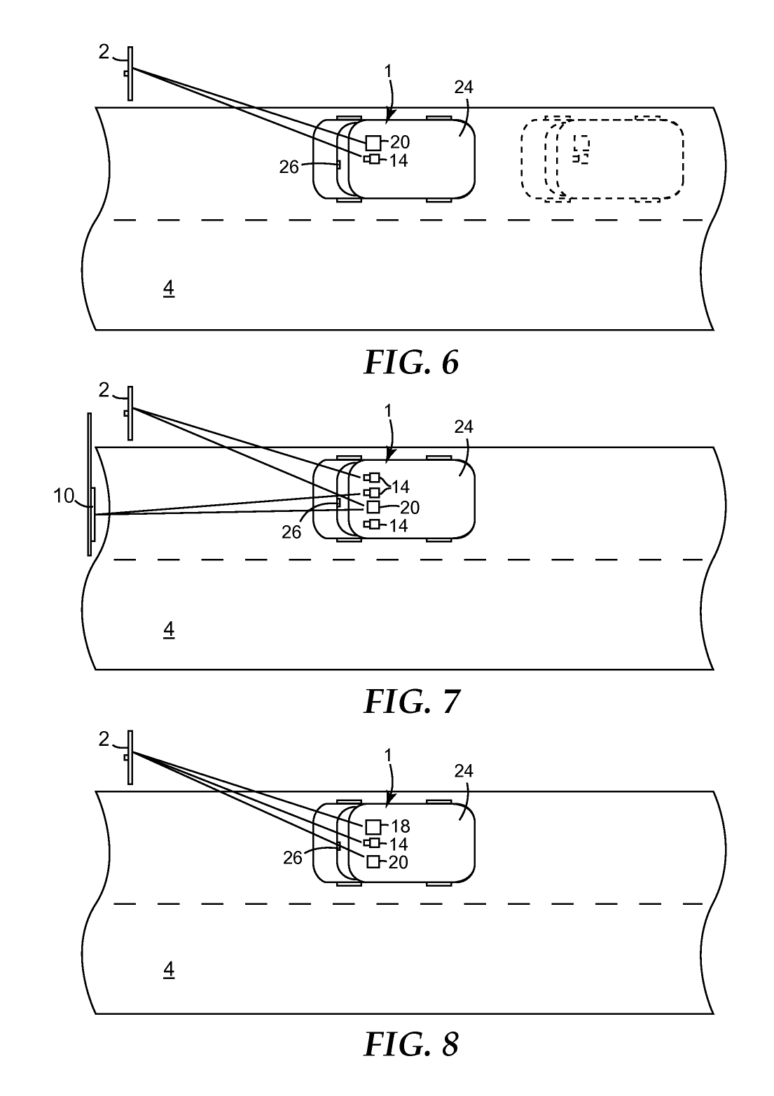

FIG. 3 illustrates one embodiment of a mobile unit, in this case a vehicle 24, including an asset assessment system of the present invention. Depending on what is desired, the asset assessment system may include a single steerable camera 14 or a plurality of cameras 14 pointing in different directions, a radio frequency identification (“RFID”) reader 18, and/or retroreflectivity measurement apparatus 20. In one embodiment, the camera(s) 14, RFID reader 18 and retroreflectivity measurement apparatus 20 are mounted on the exterior of the vehicle, in this case on the roof, however this is not necessary. Alternatively, one or more of camera(s) 14, RFID reader 18, or retroreflectivity measurement apparatuses 20 may be located within the interior of the vehicle 24. The camera(s) 14 are designed to take record images of an intended asset, as discussed in more detail in reference to FIGS. 6-8. Such camera(s) 14 may include a telephoto lens, which is helpful for zooming in on the intended asset. One example of a suitable camera is commercially available from Teledyne Dalsa located in Billerica, Mass. as Pantera™ 6M Area Scan Camera, or Genie™ Model C1600 Area Scan Camera.

The RFID reader 18 reads and/or writes information on a radio frequency-responsive element located on or within the asset. One example of a suitable RFID reader 18 is commercially available from as Sirit™ as Model Infinity 510. The retroreflectivity measurement apparatus 20 is for taking measurements of the retroreflectivity of an asset, for example the sheeting of roadway sign 2. One example of a suitable retroreflectivity measurement apparatus 20 is commercially available from Delta Light and Optics, based in Denmark as a Retrosign GR3 Retroreflectometer.

The vehicle 24 is equipped with a variety of electronics for communicating with the signs 2 and other roadway structures 3, and for communicating with a global positioning satellite system 28, a geographical information system (“GIS”) 30, and a central office information system 34, as well as for processing and managing the information received from the different components of the system and the operator of the system. In one embodiment, communication between the vehicle 24 and signs 2 and structures 3 is bi-directional communication, while in another embodiment communication is unidirectional, to vehicle 24 from signs 2 and structures 3.

Regarding one embodiment of the referenced electronics, the vehicle 24 preferably includes an on-board global positioning device 26 for interacting with a global positioning satellite system 28. The on-board global positioning device 26 receives a GPS signal from the GPS satellites and processes the signal to determine various navigational data regarding the vehicle, such as the vehicle's geographical position, heading and velocity. One suitable example of an on-board global positioning device is provided by Trimble based in Sunnyvale, Calif. as a GPS Pathfinder ProXRT receiver.

In addition, the vehicle preferably includes a computer (not shown) for receiving information from a geographical information system and the on-board global positioning system device. One suitable computer is a ViewSonic PC mini 132's Intel™ Atom™ 330 dual-core processor and nVIDIA™ ION™ chipset. A GPS module receives a GPS signal from the GPS satellites and processes the signal to determine various navigational data regarding the vehicle, such as the vehicle's position, heading and velocity. The computer can then correlate the vehicle location and compare it to information regarding sign locations stored in the geographical information system database 30. The GIS system provides information about a collection of assets, such as the signs 2 or roadway structures 3, and their respective geographical locations. A central office information system may be housed at a municipality, for example. The central office information system stores information related to the municipality's assets and provides a listing of the assets that need to be assessed in a given time frame. The central office information system may also store the location of the asset, when it was last serviced, who and when the asset was installed at its current location, past retroreflectivity measurements, and the date and any other data collected the last time the asset was assessed. The system 1 also preferable includes a communications module for facilitating communications between the central office information system and the moving vehicle 24.

In one embodiment, signs 2 and structures 3 are equipped with radio frequency-responsive elements which provide a way for the assets to communicate information electromagnetically, using radio frequency identification (“RFID”) energy, to the RFID reader 18, as described in more detail below.

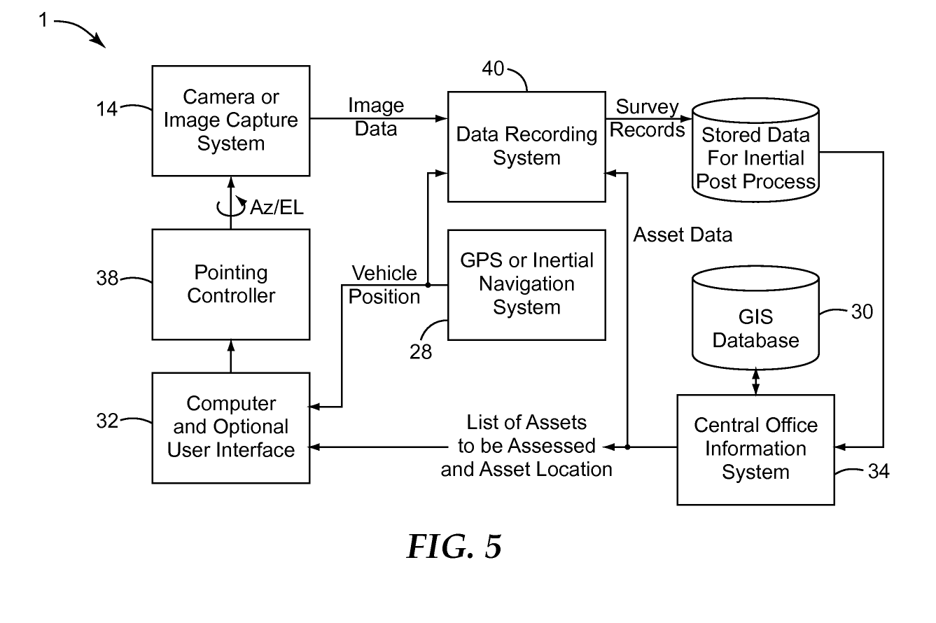

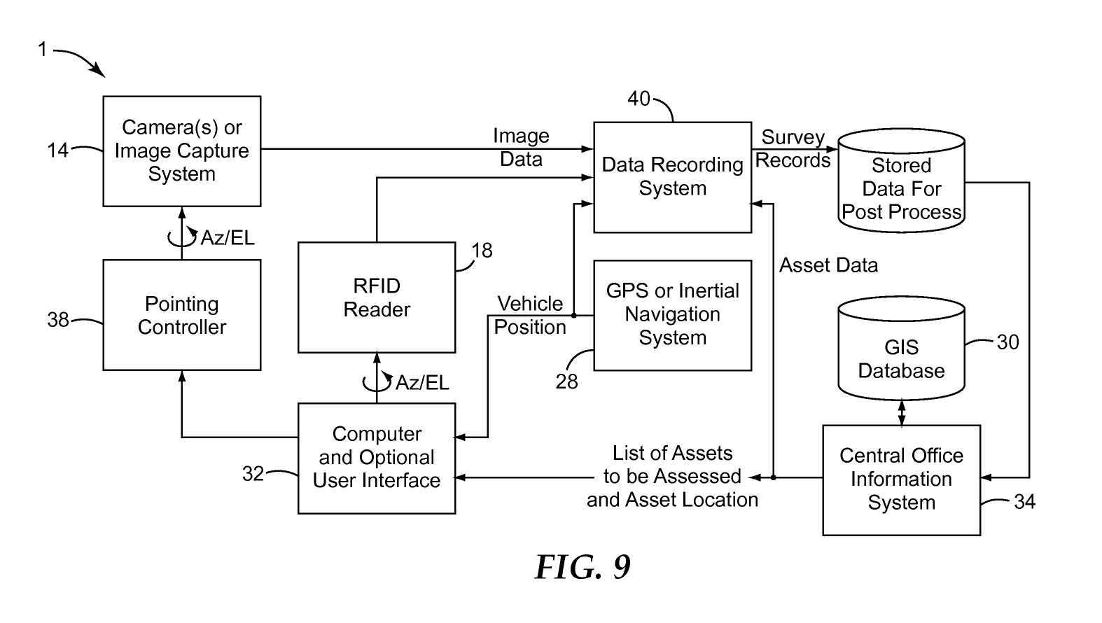

FIG. 5 illustrates a block diagram of one embodiment of the asset assessment system of the present invention, including at least one camera 14 or other type of image capture system. The camera 14 records an image of the intended asset. FIG. 9 illustrates a block diagram of another embodiment of the asset assessment system of the present invention, which is the same as the system illustrated in FIG. 5, except including a RFID reader. The block diagrams in FIGS. 5 and 9 illustrate different portions of separate embodiments of the asset assessment system, as explained in more detail below.

In the embodiments illustrated in FIGS. 5 and 9, a user first determines a list of assets that should be assessed. For example, a department of transportation worker is tasked with driving past a number of predetermined signs, such as all signs on a selected number of roads, to determine their physical condition, orientation, if they are located in the correct location, and/or to have their retroreflectivity measured. A central database resides in a central office information system 34 and stored within is information relating to each asset, including their location and an identification code or serial number for each asset in the inventory. Before leaving the central office, a list of assets is generated. Such information from the central database may then be communicated to the in-vehicle unit through the system's communication module mentioned above. Alternatively, such information may be carried in transferrable memory to the vehicle's computer, such in the form of a memory stick. Regarding each asset, two types of information may be collected and stored, permanent attributes and variable attributes. Permanent attributes are attributes that should not change with respect to an asset, and thus, the information relating thereto can be programmed during manufacturing. For example, if the assets are signs 2 or roadway structures 3, permanent attributes may include the serial number of the sign or structure, where and when the sign was manufactured, and the type of sign, such as a stop sign. Variable attributes are those attributes that can change, are not known at the time of manufacturing, or are collected at installation sites. In the case where assets are signs 2 or roadway structure 3, variable attribute information may include the authority responsible for maintaining the sign, the location of the sign or structure, the date of installation, and the status of the sign may be programmed into memory. Moreover, after any repairs are made, a maintenance record stored in the central office information can be updated, thereby providing a history of repairs with respect to the sign or structure for field workers performing future maintenance.

The central office information system compiles a list of assets to be surveyed, and in a preferred embodiment, obtains from the geographical information system 30 the geographical locations of each of the plurality of assets. The list of assets and their respective locations is then sent to a computer 32, preferably located on board the vehicle 24. The computer also receives input from the global positioning system or other inertial navigation systems. Specifically, the on-board global positioning system device 26 determines the location of the vehicle 24. The computer then determines at least one optimized route for the user to drive the vehicle to all of the assets on the list, from its current location until all of the assets on the list have been assessed. Alternatively, the computer could first determine the vehicle's current location, then identify all of the assets within a certain mileage range, 75 miles for instance, from the vehicle's current location, and then provide an optimized route to a sub-set of the list of assets to be assessed.

Referring now to FIGS. 6 and 7, after the route has been determined, the driver follows the directions provided by the on-board computer, preferably through the user interface to its first destination, where a particular asset is located. The on-board computer through its user interface computes the relative vehicle location with respect to the next sign on the list of target signs. In one embodiment, the user interface may continuously communicate the vehicle's location relative to the next asset on its list. The on-board GPS device can alert the worker when a sign is approaching, through a graphical display or an audible signal or both. As the vehicle approaches the asset, in this case, a sign 2, the computer operates a pointing controller 38. The computer calculates the optimized location of the vehicle for the camera to record an image of the selected asset. In one embodiment, the pointing controller 38 controls the direction in which a single camera 14 is pointing. Because the computer has input from the on-board GPS system for the current vehicle location, it can direct the pointing controller 38 at the selected asset 2, as illustrated in FIG. 6. Upon arriving at a predetermined location, the controller 38 causes the camera 14, or other image capture system known in the art, to record an image or multiple images of the selected asset, or at least record an image of where the selected asset is supposed to be (as discussed in more detail below). Optionally, upon arriving at a predetermined location, another controller may also cause a retroreflectivity measurement apparatus 12 to take measurements of the sign's retroreflectivity. Alternatively, one controller may control both the camera(s) 14 and retrorflectivity measurement apparatus 12. Information such as the recorded image, image date and optional retroreflectivity measurements may then be stored in a data recording system 40. The data recording system 40 may record the vehicle's position from the GPS system 28, when the image was taken. Lastly, in some embodiments of the system, the geographical information database 30, through the central office information system 34 provides the data affiliated with the asset, such as permanent and variable attributes described above. All survey data may then be stored for future post processing as survey records.

The computer may include software that operates the camera without a pointing controller and calculates what direction the camera is to be pointing in, both in terms of elevation and angle, based on received information regarding the vehicle's present location and the location of the asset sought.

The camera(s) 14 may optionally include a telephoto lens for zooming in on the desired asset. The pointing controller 38 controls the telephoto lens to optimize the image taken of the asset, as the vehicle approaches the predetermined location. The camera could alternatively include a retroreflectivity measurement apparatus, instead of having a separate unit 20.

The system 1 collects information about each asset on its designated list as it travels to each location along the provided route, referred to generally as assessment information. For example, the asset assessment system 1 can collect information about the presence or absence of the asset, sometimes referred to as “inventory information.” If the asset the system is looking for is present, then for instance, the system 1 records that the stop sign 2 is presently located at its designated location on the northeast corner of Huntington Street and Excelsior Street, as reflected by the database. The recorded image taken by a camera 14 provides evidence that the sign 2 is indeed at its recorded location. Instead, if the recorded image does not show the asset 2 sought, then the system may automatically, or manually by a user, record that the sought asset was absent at its designated location. As another example, the recorded image could show that the current condition of the sign is knocked over, due to an earlier mishap with a snow plow, or that the sign has graffiti spray painted on it. Afterwards, in post processing, the system may record that the sign 2 requires maintenance because it was knocked over or has graffiti. A user may also enter his observations through the user interface that graffiti is observed or the sign is knocked over and no longer properly visible. As yet another example, the recorded retroreflectivity measurements of the sign 2 may fail to meet certain minimum requirements, and automatically flag the sign as needing service. Alternatively, in post processing, the system 1 will record that this particular sign 2 requires servicing of its retroreflectivity features, such as perhaps new retroreflective sheeting. The system 1 may record other incidental sign evaluation information such that trees or bushes are obstructing the view of the sign, the sign has gun shots through it, the wrong sign is present, bumper stickers are stuck on the sign, etc., all of which may be manually entered by a user through a user interface, explained in more detail below. All assessment information collected by the system 1 may be recorded in a central database. For example, all the retroreflectivity measurements gathered by the system 1 may be processed, analyzed, and entered into a database, or stored in the central office information system. After being analyzed, the central office, such as a department of transportation, can prepare a report of all the signs or other structures in the county that will require new retroreflectivity sheeting due to failure of the assessed signs to meet minimum retroreflectivity measurements, for example.

FIG. 9 illustrates an embodiment of the asset assessment system useful with assets having a radio frequency identification (“RFID”) responsive element. To improve the efficiency of locating assets with the present system 1, the assets may each include a radio frequency-responsive element associated with it. In one embodiment, the radio frequency-responsive element typically includes an integrated circuit and an RFID antenna. The integrated circuit provides the primary identification function. It includes software and circuitry to permanently store the tag identification and other desirable information, interpret and process commands received from the RFID reader 12, and respond to requests for information by the RFID reader 12. Optionally, the integrated circuit may provide for updating the information stored in its memory (read/write) as opposed to just reading the information out (read only). Integrated circuits suitable for use in radio frequency-responsive elements include those available from Texas Instruments, in their TIRIS or TAG-IT line of products, and NXP, in their I-CODE, MIFARE and HITAG line of products, among others.

The antenna geometry and properties depend on the desired operating frequency of the radio frequency-responsive element. For example, 915 MHz or 2.45 GHz radio frequency-responsive elements would typically include a dipole antenna, such as a linear dipole antenna or a folded dipole antenna. A 13.56 MHz (or similar) radio frequency-responsive element would use a spiral or coil antenna. However, other antenna designs are known to those skilled in the art. In either case, the antenna intercepts the radio frequency energy radiated by the RFID reader or interrogation source. This signal energy carries both power and commands to the tag. The antenna enables the RF-responsive element to absorb energy sufficient to power the integrated circuit and thereby provide the response to be detected. Thus, the characteristics of the antenna must be matched to RFID reader in the system 1 in which it is incorporated. These characteristics are often referred to as antenna characteristic information, and such information is preferably stored in the geographical information system database 30. Antenna characteristic information may include the type of antenna, polarization of the antenna, for example whether the antenna has a linear or circular polarization. If the RFID reader 12 is unable to successfully read the radio frequency-responsive element on the asset based on the antenna characteristic information expected for the radio frequency-responsive element, then either the asset is not present, or perhaps the asset has been damaged or knocked over so that the radio frequency-responsive element is exhibiting a different orientation relative to the reader, resulting in the antenna of the reader and that of the RFID element associated with the asset not being in optimal orientation for reading. Other antenna characteristic information may include where the radio frequency-responsive element is located on the asset, such as a sign. Such information is helpful as the computer directs the steerable antenna in the expected direction of the RF-responsive element. For example, a radio frequency-responsive element may be mounted on the back of a sign, or below a sign. In a preferred embodiment, the RFID reader 18 is selected so as to optimize the steerable antenna to successfully read most radio frequency-responsive elements attached to assets.

The steerable RFID antenna of the RFID reader 18 may include different embodiments. In one embodiment, the steerable RFID antenna includes a mechanically driven servo high gain antenna. In another embodiment, the steerable RFID reader includes electronically steered arrays with phase shifters. In yet another embodiment, the steerable RFID reader includes a plurality of fixed beams that may be simultaneously excited. In another embodiment, the steerable RFID reader includes a plurality of antennas pointing in different directions, similar to the multiple cameras illustrated in FIG. 6, and includes a controller for selecting one of said plurality of antennas to read a radio frequency-responsive element. One suitable commercially available RFID reader is the Sirit™ Model Infinity 510. One suitable commercially available steerable RFID antenna is the Scala Model TY-900.

There are several benefits affiliated with having RFID functionalities built into the system 1. RFID provides verification that the asset being assessed by the system is actually the one recorded on the geographical information system database. In essence, it is a crosscheck that the database has correct information stored about each of the assets. With RFID, the exact identification of the asset is certain due to the unique serial number affiliated with the radio frequency-responsive element on the asset. Unfortunately, assets may get moved or lost, and by not reading or properly locating the exact radio frequency identification element searched for, the system may provide confirmation that such asset is lost. In addition, since the system provides the orientation information about the individual radio frequency-responsive element, if the asset were not properly orientated, for instance if it was a sign knocked over on its side, the antenna of the radio frequency-responsive element would likewise not be orientated correctly, resulting in a potential misread or nonread situation. In post processing, the asset would then be flagged for maintenance. Because the RFID antenna is steerable, it may be steered in the direction of where it expects the radio frequency responsive element to be relative to the asset location, and if there is a successful read, then the system records that asset is present. Likewise, an unsuccessful read would indicate the asset or its radio frequency responsive element needs servicing.

In one embodiment, the radio frequency-responsive element can be installed on a separate support near sign 2 or more preferably on the infrastructure supporting sign 2 or structure 3. In a more preferred embodiment, however, the radio frequency-responsive element is integrated with sign 2 or structure 3 to be able to use existing infrastructure to support the electronic road signs, and to provide for ease of installation, to reduced costs, to avoid tampering and other for safety considerations. Moreover, if the radio frequency-responsive element is integrated with sign 2 during manufacturing, it reduces the probability of error in programming at a field site. Examples of mounting a radio frequency-responsive element or integrating a radio frequency-responsive element into an asset, such as a sign 2 or structure 3, are disclosed in PCT Publication No. WO 96/35196, “Automated Sign Inventory System,” (Bantli et al.), which is hereby incorporated by reference.

One example of retroreflective sheeting materials useful for signs having radio frequency-responsive elements is described in commonly-assigned U.S. Pat. No. 4,588,258 to Hoopman issued May 13, 1986. Because the cube-corner retroreflective sheeting utilizes a dielectric material, it may be used as retroreflective sheeting of a sign as it may be placed in front of an radio frequency-responsive element without inhibiting the transmission of its radio signals.

Another form of suitable radio frequency-responsive element is disclosed in PCT Publication WO 2010/080778, “RFID Packaging and Attachment Methods and Devices, (Banerjee et al.), which is hereby incorporated by reference. In this publication, an RFID-enabled roadway sign is disclosed, where a strap or interposer provides an integrated circuit and the sign sheeting provides the antenna portion for the radio frequency-responsive element. This embodiment of the radio frequency-responsive element is very suitable for use with the system 1 of the present invention because the radio frequency-responsive element and sign are provided as one incorporated unit.

The radio frequency-responsive elements may have information programmed into their memories related to the asset to which they are attached. Such information may be stored when the radio frequency-responsive element is integrated with an asset during manufacturing, or may be programmed when the asset is placed in the field in its final location. Such information may include permanent or variable attributes, as discussed above.

FIG. 9 illustrates a block diagram of another embodiment of the asset assessment system of the present invention, which is the same as the system illustrated in FIG. 5, except including an additional RFID reader 18. In the embodiment illustrated in FIG. 9, a user first determines a list of assets that should be assessed. For example, a list of signs 2 may be compiled to enable the signs to be surveyed to determine if signs are located in their correct locations, or to have the retroreflectivity measured of the sign sheeting to see if it meets minimum requirements. The central office information system 34 contains information about each asset, from which a list of assets is generated, including information about the individual radio frequency-responsive elements that are each associated with the particular asset. In addition, the central office information system may also provide permanent attribute and variable attribute information, as discussed above. After any repairs are made, the maintenance record stored in the central office information may be updated, thereby providing a history of repairs of the sign or structure for field workers performing future maintenance.

The central office information system 34 complies a list of assets to be assessed. The central office information system 34 initially receives input from the geographical information system 30, which provides the geographical locations of each of the plurality of assets and their respective radio frequency-responsive element information. The list of assets, their respective locations, and their respective radio frequency-responsive element information is then sent to a computer 32. The computer also receives input from the global positioning system or other inertial navigation systems through the on-board global positioning system device 26, which determines the current location of the vehicle 24. As mentioned above, the computer then determines at least one optimized route for the user to drive the vehicle to all of the assets on the list, from its current location until all of the assets on the list have been assessed. Alternatively, the computer could first determine the vehicle's current location, and then identify all of the assets within a certain mileage range, 75 miles for instance, from the vehicle's current location, and provide an optimized route to a sub-set of the list of assets to be assessed.

Referring now to FIG. 8, after the route has been determined, the driver follows the directions provided by the computer to its first destination, where a particular asset is located. As the vehicle approaches the asset, in this case, a sign 2, the computer steers the antenna of the RFID reader 18 in the direction of the expected radio frequency-responsive element of the asset sought. Upon a successful read by the RFID reader 18 of the radio frequency-responsive element, the system can verify that the correct asset is indeed present, and then the computer may operate the pointing controller 38 to record an image with the camera 14 or other image capture system. Because the computer has input from the on-board GPS system for the current vehicle location, it can direct the pointing controller 38 at the selected asset 2 upon obtaining a successful read of the radio frequency-responsive element associated with the asset. As mentioned previously, instead of a single camera and a pointing controller, the system 1 may be equipped with multiple cameras pointing in different directions, and the computer may select the camera pointing in the direction of the asset upon obtaining a successful read of the radio frequency-responsive element associated with the asset to record an image of the asset. Optionally, the system could take an image of the asset or the position of the expected asset upon either a successful or unsuccessful read of the radio frequency identification element. Optionally, upon arriving at a predetermined location, the computer may also cause a retroreflectivity measurement apparatus 12 to take measurements of the sign's retroreflectivity. The photo or image data, the information read from the radio frequency-responsive element attached to the selected asset, and optional retroreflectivity measurements of the selected asset are then preferably stored in a data recording system 40. The data recording system 40 also records the vehicle's position from the GPS system 28, when the image was taken. Lastly, the survey control system 36 provides the data affiliated with the asset, such as permanent and variable attributes described above. All survey data may then be stored for future processing as survey records in a record system not affiliated with the vehicle. As another option, the information on the radio frequency-responsive element may be updated or new information written, after the radio frequency-responsive element is successfully read by the RFID reader. For example, the date of the assessment could be recorded on the radio frequency-responsive element itself or the current retroreflectivity measurements, if any were taken of the sign 2.

System 1 may include an optional user interface which allows personnel using the system 1 to read and input information about the assets. The user interface may include a user display, such as a computer monitor or an LCD display to provide images and information to the user. The user interface may also include an input device, such as a keyboard or mouse and pointer, used by the department of transportation personnel to request desired information and input other commands. In one embodiment, user display and input device are combined in a single unit, such as a touch screen with a graphical user interface.

Further, an audible signal module may be included in the system 1 to provide audible signals to the user in situations where the user's attention is required, such as when a desired sign 2 is approaching. Additionally, removable memory, such as a diskette or a smart card, may be provided to allow related information to be stored and modified in a single memory unit that can be inserted when needed and removed and stored at a central office when not needed. Further, a voice input module may be included in the system 1 to allow the user, who is typically driving a vehicle, to input voice commands rather than manual input of commands. Additionally, wireless functionality may be included in the system 1 to provide transfer of the recorded images and other assessment information gathered. Lastly, a printer port may be provided to allow connection of the in-vehicle system 1 to a printer to provide hard copies of information.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. An asset assessment system, comprising:
a plurality of assets located at various geographical locations;
a geographical information system database for providing information relating to geographical locations of the plurality of assets;
an on-board global positioning system device;
a camera;
a pointing controller, wherein the camera is attached to the pointing controller; and
a computer, wherein the computer receives information from the geographical information system database and the global positioning system device to direct the pointing controller where to point the camera.

2. The asset assessment system of claim 1, wherein the camera pointed at a selected asset from the plurality of assets records at least one image of the selected asset.

3. The asset assessment system of claim 1, further comprising a retroreflectivity measurement apparatus.

4. The asset assessment system of claim 1, wherein the plurality of assets include roadway signs or roadway structures.

5. The asset assessment system of claim 1, further comprising a user interface to allow a user to read information and input information about the assets.

6. The asset assessment system of claim 1, wherein the system collects assessment information about the asset, and wherein the assessment information includes inventory, maintenance, or incidental sign evaluation information.

7. The asset assessment system of claim 1, further comprising a radio frequency identification (“RFID”) reader with a steerable antenna, wherein each asset includes a radio frequency-responsive element, and wherein the computer steers the RFID antenna in the direction of a selected asset from the plurality of assets to read information from the radio frequency-responsive element of the selected asset.

8. The asset assessment system of claim 1, further comprising a database for storing all information gathered by the asset assessment system relating to the plurality of assets.

9. The asset assessment system of claim 1, wherein the computer calculates the optimized location of the vehicle for the camera to take a image of a selected asset, and communicates directions to a driver of the vehicle to that optimized position.

10. An asset assessment system, comprising:
a plurality of assets located at various geographical locations;
a geographical information system database for providing information relating to geographical locations of said plurality of assets;
an on-board global positioning system device;
a plurality of cameras directed at different positions; and
a computer, wherein the computer receives information from the geographical information system database and the global positioning system device and selects a camera from the plurality of cameras.

11. The asset assessment system of claim 10, wherein the camera pointed at a selected asset records at least one image of the selected asset from the plurality of assets.

12. The asset assessment system of claim 10, further comprising a retroreflectivity measurement apparatus.

13. The asset assessment system of claim 10, wherein the plurality of assets include roadway signs or roadway structures.

14. The asset assessment system of claim 10, further comprising a user interface to allow a user to read information, and input information about the assets.

15. The asset assessment system of claim 10, wherein the system collects assessment information about the asset, and wherein the assessment information includes inventory, maintenance, or incidental sign evaluation information.

16. The asset assessment system of claim 10, further comprising a radio frequency identification (“RFID”) reader with a steerable RFID antenna, wherein each asset includes a radio frequency-responsive element, and wherein the computer steers the RFID antenna in the direction of a selected asset from the plurality of assets to read information from the radio frequency-responsive element of the selected asset.

17. The asset assessment system of claim 10, further comprising a database for storing all information gathered by the asset assessment system relating to the plurality of assets.

18. The asset assessment system of claim 10, wherein the computer calculates the optimized location of the vehicle for the camera to take an image of a selected asset, and communicates directions to that optimized position.

19. An asset assessment system, comprising:
a plurality of assets located at various geographical locations, wherein each asset includes a radio frequency-responsive element;
a geographical information system database for providing information relating to geographical locations of said plurality of assets and the individual radio frequency-responsive element information for each asset;
an on-board global positioning system device;
a radio frequency identification (“RFID”) reader with a steerable RFID antenna; and
a computer, wherein the computer receives information from the geographical information system database and the global positioning system device and steers the RFID antenna in the direction of a selected asset from the plurality of assets to read information from the radio frequency-responsive element of the selected asset.

20. The asset assessment system of claim 19, wherein a selected radio frequency-responsive element has an antenna characteristic information, and the antenna characteristic is included in the geographical information system database.

21. The asset assessment system of claim 19, wherein the steerable antenna is optimized to read the selected radio frequency-responsive element based on its antenna characteristic information.

22. The asset assessment system of claim 19, further comprising a pointing controller and a camera attached to the second pointing controller; and wherein the computer directs the pointing controller where to point the camera.

23. The asset assessment system of claim 19, wherein the camera pointed at a selected asset records at least one image of the selected asset.

24. The asset assessment system of claim 19, further comprising a retroreflectivity measurement apparatus.

25. The asset assessment system of claim 19, wherein the plurality of assets include roadway signs or roadway structures.

26. The asset assessment system of claim 19, further comprising a user interface to allow a user to read information.

27. The asset assessment system of claim 19, wherein the system collects assessment information about the asset, and wherein the assessment information includes inventory, maintenance, or incidental sign evaluation information.

28. The asset assessment system of claim 19, further comprising a database for storing all information gathered by the asset assessment system relating to the plurality of assets.

29. The asset assessment system of claim 19, wherein the computer calculates the optimized location of the vehicle for the RFID antenna to read the radio frequency-responsive element of a selected asset, and communicates directions to that optimized location.

30. A method of assessing assets, comprising:
providing a geographical information system database for providing information relating a plurality of assets located at various geographical locations and the geographical locations of the plurality of assets;
providing a camera to take an image of a selected asset;
providing a global positioning system device;
positioning the camera based on information about a selected asset from the geographical information system database and from the global positioning system; and
taking an image of the selected asset.

31. The method of claim 30, further comprising the step of:
measuring retroreflectivity of the selected asset.

32. The method of claim 30, wherein the plurality of assets include roadway signs or roadway structures.

33. The method of claim 30, further comprising the step of:
collecting assessment information about the selected asset, wherein the assessment information includes inventory, maintenance, or incidental sign evaluation information.

34. The method of claim 30, further comprising the steps of:
providing further a radio frequency identification (“RFID”) reader with a steerable antenna, wherein each asset includes a radio frequency-responsive element;
steering the RFID antenna in the direction of a selected asset from the plurality of assets to read information from the radio frequency-responsive element of the selected asset.

35. The method of claim 30, further comprising the step of:
calculating the optimized location of the vehicle for the camera to take an image of a selected asset; and
communicating directions to a driver of the vehicle to that optimized location.
